(19) United States
(12) Patent Application Publication
(10) Pub. No.: US 2014/0258247 A1
(43) Pub. Date: Sep. 11, 2014

(54) ELECTRONIC APPARATUS FOR DATA ACCESS AND DATA ACCESS METHOD THEREFOR

(71) Applicant: HTC Corporation, Taoyuan County (TW)

(72) Inventors: Shih-Hung Chu, Taoyuan County (TW); Yu-Hsin Liang, Taoyuan County (TW)

(21) Appl. No.: 13/785,836

(22) Filed: Mar. 5, 2013

(51) Int. Cl. G06F 17/30

(52) U.S. Cl. CPC G06F 17/30153
USPC 707/693

(57) ABSTRACT

Electronic apparatus for data access and data access method therefor are provided. The electronic apparatus includes: a memory unit and a processing unit. The processing unit includes a processor, a memory mapping unit, and a compression and decompression unit. The memory mapping unit is for performing conversion of a virtual address and a physical address for a read or write operation in the memory unit by the processor. The compression and decompression unit, coupled between the processor and memory unit, is for performing selectively data compression or decompression for the read or write operation in the memory unit by the processor. The processing unit enables the compression and decompression unit to compress data to be written and to accordingly output the corresponding compressed data to the memory unit when the processing unit determines that a compression criterion is satisfied, wherein the compression criterion includes: whether an idle rate of the processing unit is greater than a first threshold.

### BACKGROUND

1. Technical Field

The disclosure relates to an electronic apparatus for data access and a data access method therefor, wherein a processing unit of the electronic apparatus has data compression functionality.

2. Description of the Related Art

Nowadays, electronic devices such as smart phones and tablet computers, equipped with versatile functionality, may have their memory not enough for usage because the users frequently download and update application programs from the software market, leading to rapid data access. In addition, since the smart phones and tablet computers are intended for providing good user experience, the manufacturers employ various approaches, such as utilizing processors with higher operating frequencies or multiple cores to speed up the execution of the application programs, so as to make the users experience the smoothness of use, enhancing the productivity of the electronic devices.

The manufacturers generally fulfill the demand of the users by providing the electronic devices equipped with memory of higher memory space and processor of a higher speed. However, such approach will relatively increase the price as well as the cost, which is not conducive to popularization. Besides, the problem still cannot be resolved for middle or low level products.

### SUMMARY

Embodiments are provided for an electronic apparatus for data access and a data access method therefor.

One embodiment of the disclosure provides an electronic apparatus for data access, including: a memory unit and a processing unit. The processing unit includes: a processor, a memory mapping unit, and a compression and decompression unit. The memory mapping unit, coupled between the processor and the memory unit, is for performing conversion of a virtual address and a physical address for a write or read operation in the memory unit by the processor. The compression and decompression unit, coupled between the processor and the memory unit, is for selectively performing data compression or data decompression for a write or read operation in the memory unit by the processor. When the processing unit determines that a compression criterion is satisfied, the processing unit enables the compression and decompression unit to compress data to be written and accordingly output corresponding compressed data to the memory unit, wherein the compression criterion includes: whether an idle rate for the processing unit is greater than a first threshold.

According to another embodiment, a data access method is provided for use in an electronic apparatus, including the following steps. A determination is made by a processing unit of the electronic apparatus as to whether a compression criterion is satisfied, wherein the compression criterion includes: whether an idle rate for the processing unit is greater than a first threshold. When the compression criterion is satisfied: enabling a compression and decompression unit of the processing unit to enter a compression mode is made; and compressing data to be written and accordingly outputting corresponding compressed data to the memory unit is performed by the compression and decompression unit.

### BRIEF DESCRIPTION OF THE DRAWINGS

FIG. 1 is a block diagram of an embodiment illustrating a processing unit of an electronic device accessing a memory unit.

FIG. 2 is a block diagram of an embodiment of a processing unit.

FIG. 3 is a flowchart of an embodiment of a data access method.

FIG. 4 is a flowchart of another embodiment of a data access method.

FIG. 5 is a flowchart of still another embodiment of a data access method.

In the following detailed description, for purposes of explanation, numerous specific details are set forth in order to provide a thorough understanding of the disclosed embodiments.

### DETAILED DESCRIPTION

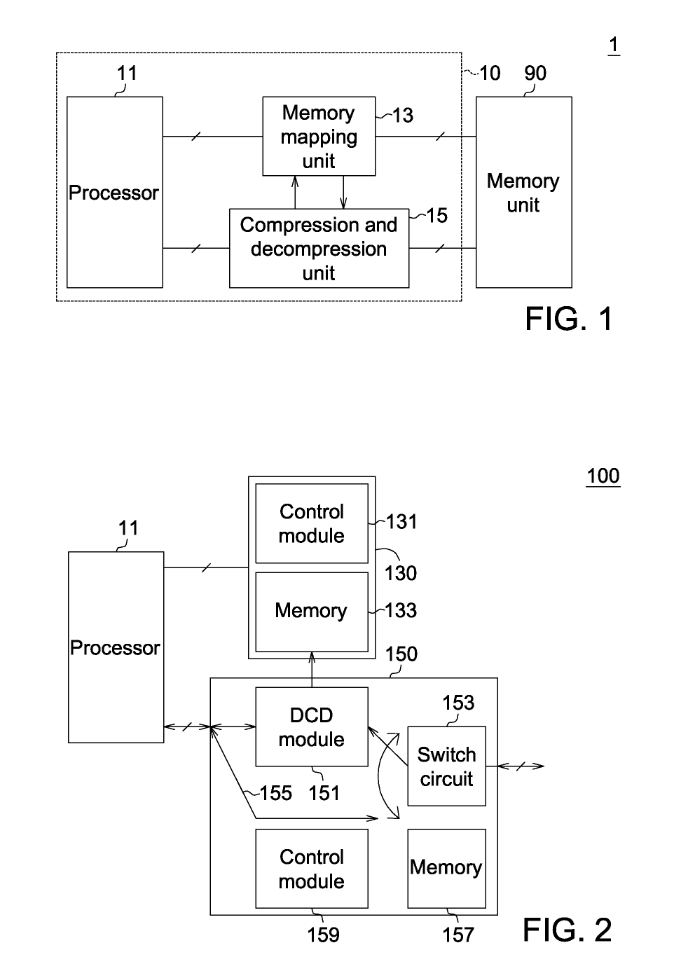

Referring to FIG. 1, a block diagram of an embodiment illustrating a processing unit of an electronic device accessing a memory unit is provided. Based on the structure of FIG. 1, an electronic apparatus 1 can be implemented as an electronic device including a processing unit 10 and a memory unit 90, such as: a smart phone, tablet computer, portable device, multimedia device, digital camera and so on. The processing unit 10 has built-in circuitry configured to perform data compression or decompression selectively. In some embodiments, the electronic apparatus 1 can save the storage space in the memory unit 90 (e.g., including the main memory and secondary memory) and enhance the efficiency in software installation.

In FIG. 1, the processing unit 10 includes: a processor 11, a memory mapping unit 13, and a compression and decompression unit 15. The processor 11, for example, is a single- or multiple-core processor. The memory mapping unit 13, coupled between the processor 11 and the memory unit 90, is for performing conversion of a virtual address and a physical address for a write or read operation in the memory unit by the processor. Hence, virtual addresses are transferred between the processor 11 and the memory mapping unit 13; physical addresses are transferred between the memory mapping unit 13 and the memory unit 90.

The compression and decompression unit 15, coupled between the processor 11 and the memory unit 90, is for selectively performing data compression or data decompression for a write or read operation by in the memory unit 90 the processor 11. The compression and decompression unit 15 may be implemented, for example, using data compression and decompression computation circuitry based on one or more algorithms for data compression and decompression, or using a processing circuit performing data compression and decompression software (such as a gzip engine), wherein a lossless data compression algorithm, such as Sliding Window Algorithms, Dictionary Algorithms, Non-dictionary Algorithms, may be adopted. When the processing unit 10 performs data access operation such as write or read operation, e.g., in response to write or read instruction, the processing unit 10 determines whether to utilize the compression and decompression unit 10 to perform compression or decompression or not to perform compression operation, wherein the memory mapping unit 13 provides corresponding physical addresses for data access operation by the compression and decompression unit 15.

FIG. 2 is a block diagram of an embodiment of a processing unit. The processing unit 100 includes a processor 11, a memory mapping unit 130, and a compression and decompression unit 150. The memory mapping unit 130 includes: a control module 131 and a memory 133. The control module 131, is for performing conversion of a virtual address and a physical address for a write or read operation in the memory unit by the processor 11, according a compression record table stored in the memory 133, and providing corresponding physical address for data access operation by the compression and decompression unit 15.

The compression and decompression unit 15 includes: a data compression and decompression (DCD) module 151, a switch circuit 153, a bypass data path 155, and a memory 157. The data compression and decompression module 151 is for selectively performing data compression or decompression. The bypass data path 155 is for outputting the data to be written to the memory unit 90 in a bypassing manner. The data compression and decompression module 151 and the bypass data path 155 are coupled in parallel between the switch circuit 153 and the processor 111. The memory 157 is used by the data compression and decompression module 151. In some embodiment, the memory 157 can be a memory embedded into the data compression and decompression module 151.

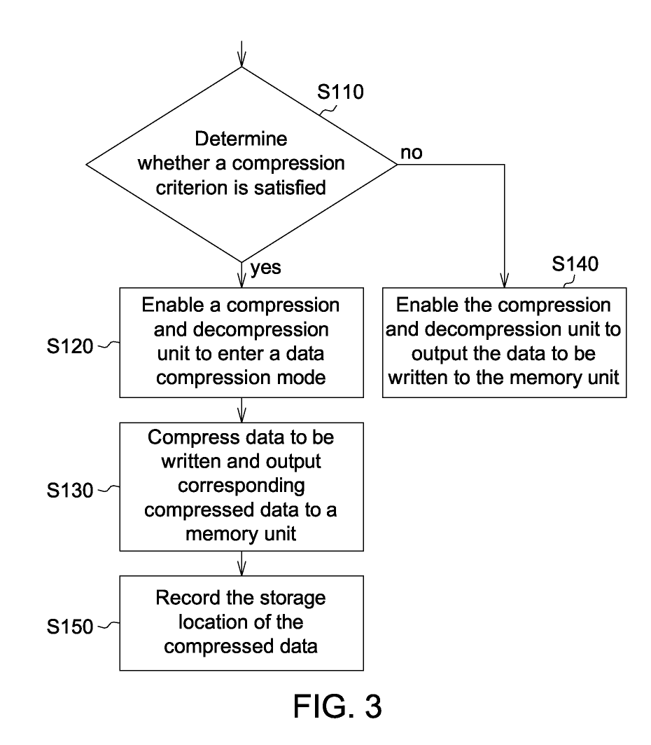

FIG. 3 is a flowchart of an embodiment of a data access method, for use in write operation by the processing unit as in FIG. 1 or 2 against the memory unit 90.

In an embodiment, as in step S110, it is determined by a processing unit of the electronic whether a compression criterion is satisfied device, wherein the compression criterion may include one or more sub-criteria, for example: whether an idle rate for the processing unit is greater than a first threshold, such as 50%, 60%. The determination as in step S110 is performed, for example, when the processing unit handles data to be written, or in response to a write instruction associated with data to be written. In step S120, when the compression criterion is satisfied, a compression and decompression unit of the processing unit is enabled to enter a compression mode. In step S130, data to be written is compressed and accordingly corresponding compressed data is outputted to a memory unit of the electronic apparatus, by the compression and decompression unit.

In step S140, when the compression criterion is not satisfied, the compression and decompression unit is enabled to output the data to be written to the memory unit.

In the above embodiment, when the compression criterion is satisfied, for example, when the idle rate for the processing unit satisfies the criterion, the data to be written can be compressed and then written into the memory unit. In this way, the situation in which the entire performance is affected by compression for data to be written at a low idle rate, i.e., a high usage rate, for the processing unit can be prevented.

Thus, a suitable compression criterion can be configured for the design requirement of an electronic apparatus, for example, further including: whether a write instruction associated with the data to be written has a priority not less than a second threshold. For instance, the priority of write instructions can be categorized into two or more levels by requirements: such as, one of high, middle, low priority, in this case, the second threshold can be set to high or middle priority. As an example, data to be written for some application programs are required to be first in, first out, and hence the priority of the write instruction can be set to the high priority. The compression criterion may further include: whether the data to be written is of a type of compressed data. For example, if the data to be written is of a type of compressed data, such as a files of format for APK, ARJ, ZIP, RAR, Z, gz and so on, then step S140 can be performed to avoid redundant compression. In some examples, if the data to be written is a file, the determination can be made according to its file name (such as extension) or its header or identification.

In addition, the determination of the step S110 and the enabling of the compression and decompression unit can be implemented by the memory mapping unit 13 or the control module 131 of the memory mapping unit 130 or the processor 11. The information for the determination of the compression criterion, such as the idle rate for the processing unit, can be obtained by the processor 11 from the operating system, such as Android, iOS, OSX, Windows or other, executed by the electronic apparatus 1. Besides, in step S110, the idle rate is used for a criterion for determination, and other equivalent or similar criterion for determination, such as whether a usage rate for the processing unit is less than a threshold, can also be implemented as the criterion; thus, the implementation is not limited thereto.

Further, for the processing unit 100 of FIG. 2, step S130 can be implemented by the data compression and decompression module 151 to compress the data to be written and output the corresponding compressed data to a memory unit of the electronic apparatus through the switch circuit 153, such as a multiplexer or switching circuitry. In step S140, when the compression criterion is not satisfied, the compression and decompression unit is enabled to output the data to be written to the memory unit in a bypassing manner, that is, the bypass data path 155 and switch circuit 153.

In an embodiment, the above method may further include step S150 to record the storage location of the memory unit in which the corresponding compressed data is stored by updating a compression record table or generating related record in other form. When the processing unit reads data, the compression record table of this embodiment can be used in determining whether the data to be read is compressed data. The compression record table may be stored in the memory mapping unit 13 or the memory 133 of the memory mapping unit 130. However, the related record is not limited thereto; for example, it can be stored in a memory device outside the memory mapping unit 13.

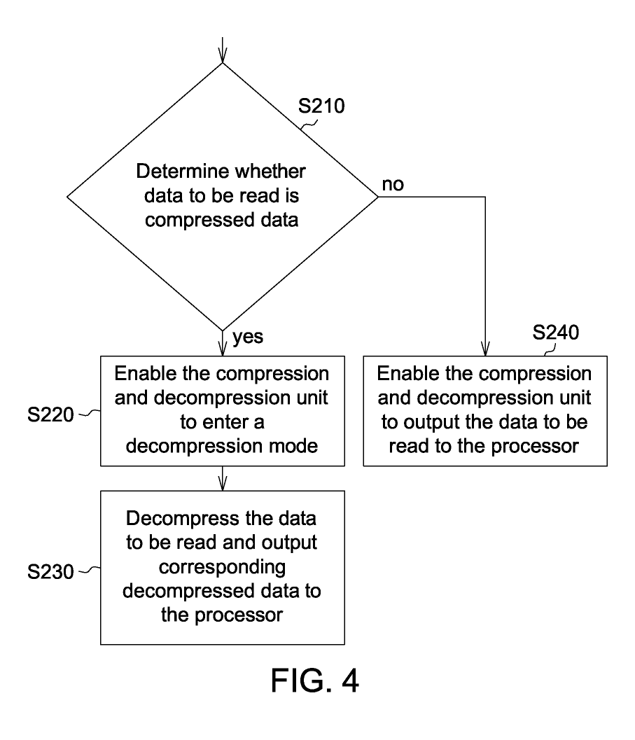

Referring to FIG. 4, a flowchart of another embodiment of a data access method is provided, which is suitable for use in performing read operation by the processing unit as in FIG. 1 or 2 against the memory unit 90. As shown in step S210, it is determined, by the processing unit, for example, a memory mapping unit (or the control module 131 of the memory mapping unit 130), whether the data of the memory unit to be read is compressed data, wherein the determination can be made according to the compression record table or other form of related record. For example, the processing unit makes the determination of step S210 when handling the data to be read or in response to a read instruction associated with the data to be read. In step S220, if the determination is affirmative, enabling the compression and decompression unit (or the data compression and decompression module 151 of the compression and decompression unit 150) to enter a compression mode is performed by the memory mapping unit. In step S230, decompressing the data to be read and accordingly outputting corresponding decompressed data to the processor are performed by the compression and decompression unit. In step S240, when the determination is negative, enabling the compression and decompression unit to output the data to be read to the processor is performed by the memory mapping unit, for example, in a bypassing manner, such as outputting by the switch circuit 153 and the data path 155.

The above embodiment shows that the memory mapping unit determines whether to decompress the data to be read according to the compression record table. For example, the compression record table can be implemented as storing locations, e.g., one or some blocks, pages, or sectors, of compressed data stored in physical memory space of the memory unit in terms of blocks, pages, or other data unit. As an example, the compression record table can be realized by a mapping table for recording actual storage locations of compressed data, such as ones as indicated in block, page, or sector. For example, a mapping table, as indicated in Table 1, records a physical page number, denoted by PPN1 (e.g., 1000), in memory corresponding to a logical sector number, denoted by LSN1 (e.g., 100), for a piece of data; and, for another piece of data, a logical sector number, denoted by LSN2 (e.g., 200) corresponding to a physical page number, denoted by PPN2 (e.g., 2000). In addition, a physical page number corresponding to a specific logical sector number may vary with the situation of the physical memory; for example, the data in LSN1 has been changed, the address of LSN1 does not change, but the data size and length, after compression, has been changed and the system then stores the compressed data in PPN3 so that the data in PPN1 is removed in order for the other user to use. The compression record table may further record related attributes for data compression, for example, the format of data compression.

TABLE 1

| Logical sector number | Physical page number |
|---|---|
| LSN1 | PPN1 |
| LSN2 | PPN2 |

Moreover, in one embodiment, after the writing of the compressed data, the processing unit may update the content of the compression record table with respect to the situation of the write operation. Nevertheless, the implementation of the compression record table is not limited to the above. In another embodiment, the processing unit may, during the writing of the compressed data, add related information into the compressed data, such as making amendments to or adding: file header, flag, or identification of the compressed data; and afterwards, during the compressed data being accessed (e.g., being read), update the content of the compression record table with respect to the compressed data. As such, the method for use in read or write operation by the processing unit as shown in FIG. 1 or 2 is not limited thereto, and can be implemented by other approaches.

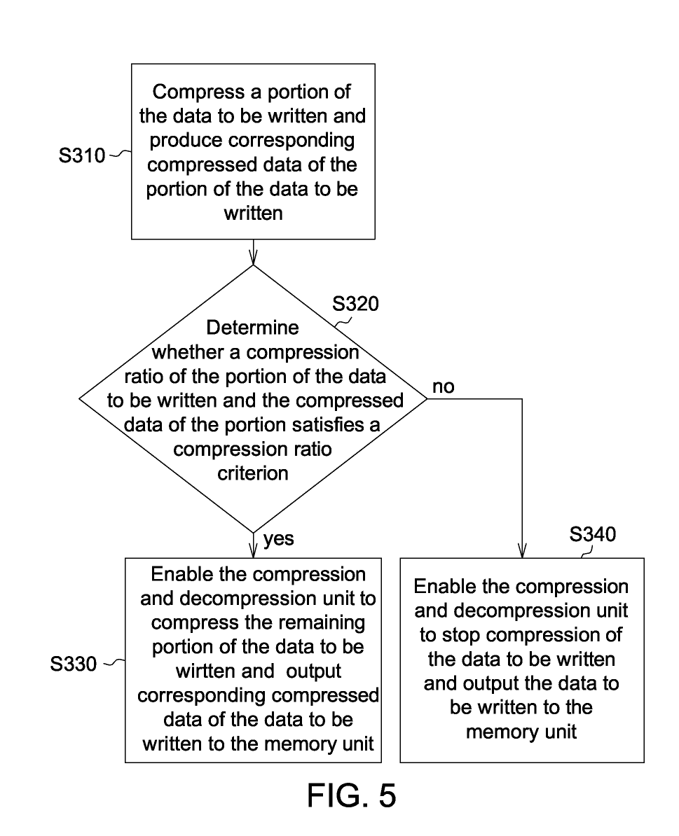

Further, for the data access method as shown in FIG. 3, in some situations, the compression criterion of step S110 may be satisfied but the data to be written may be itself compressed data or the compression result is poor. In worse cases, it may result in the dissipation of the computing resource or electricity of the electronic device, and may further lead to an larger data amount for the written compressed data. In order to avoid poor data compression result, the data access method of FIG. 3 may further implement the steps as shown in FIG. 5. In step S310, the compression and decompression unit (or the data compression and decompression module 151) compresses a portion of the data to be written (e.g., a plurality of sectors or pages of data of the data to be written) and accordingly produces corresponding compressed data of the portion of the data to be written. In step S320, the processing unit determines whether a compression ratio of the portion of the data to be written and the corresponding compressed data of the portion satisfies a compression ratio criterion. In step S330, if the compression ratio criterion is satisfied, the compression and decompression unit is enabled to compress the remaining portion of data to be written and output the corresponding compressed data of the data to be written to the memory unit. In step 340, if the compression ratio criterion is not satisfied, the compression and decompression unit is enabled to stop compression for the data to be written and output the data to be written to the memory unit.

The above embodiment shows that the processing unit can prevent the data to be written which may have poor compression result from being compressed. For example, the data to be written is a file. The portion of the data to be written as in step S310 can be the beginning portion, or one or a plurality of blocks of data of the file. A determination as to whether the compression criterion is satisfied, as indicated in step S320, can be realized in various approaches. For example, a determination is made as to whether a compression ratio, defined by the data amount of the portion of the data to be written dividing the data amount of the corresponding compressed data of the portion is less than a compression threshold, wherein the compression threshold is a number not greater than one, e.g., 1, 0.8, or 0.7. As another example, a determination is made as to whether the data amount of the corresponding compressed data of the portion is less than the data amount of the portion of the data to be written, or less than the latter times a compression threshold. Thus, the determination of step S320 can be implemented in any equivalent manner and not limited to the above examples.

In addition, steps S310-S340 of FIG. 5 can be regarded as another embodiment of step S130 of FIG. 3. In some embodiments, step S310-S340 can be performed selectively according to a specific situation or condition of the electronic device after the determination of step S110.

In another embodiment, a control module 159 can be further implemented in the compression and decompression unit 150 of FIG. 2 to perform the operations of enabling, determination, controlling the data compression and decompression module 151 for compression and outputting in step S310-S330, and perform the operation of control and outputting in step S340.

The electronic apparatus and data access method are disclosed in the above embodiments. In some practical applications, the usage space of memory can be saved efficiently, reducing the required amount of memory since the processing unit has the capability to decompress by hardware. Besides, since application programs for installation is decompressed data, for example, ZIP files, such as APK files in Android system, decompression can be performed for this by using the above embodiment, in order to speed up the installation of software, bringing better user experiences for the users. Further, in other practical applications, faster installation of system software updates or firmware can be obtained.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An electronic apparatus for data access, comprising:
a memory unit; and
a processing unit including:
a processor;
a memory mapping unit, coupled between the processor and the memory unit, for performing conversion of a virtual address and a physical address for a write or read operation in the memory unit by the processor; and
a compression and decompression unit, coupled between the processor and the memory unit, for selectively performing data compression or data decompression for the write or read operation in the memory unit by the processor;
wherein when the processing unit determines that a compression criterion is satisfied, the processing unit enables the compression and decompression unit to compress data to be written and accordingly output corresponding compressed data to the memory unit, wherein the compression criterion includes: whether an idle rate for the processing unit is greater than a first threshold.

2. The apparatus according to claim 1, wherein the compression criterion further includes:
whether a write instruction associated with the data to be written has a priority not less than a second threshold; and
whether the data to be written is of a type of compressed data.

3. The apparatus according to claim 1, wherein the compression and decompression unit outputs the corresponding compressed data to the memory unit and records a storage location of the corresponding compressed data.

4. The apparatus according to claim 3, wherein when the processing unit determines that the compression criterion is not satisfied, the compression and decompression unit outputs the data to be written to the memory unit.

5. The apparatus according to claim 1, wherein the processing unit further enables the memory mapping unit to determine whether the data to be read is compressed data; if the determination is affirmative, the memory mapping unit further enables the compression and decompression unit to decompress the data to be read and accordingly output corresponding decompressed data to the processor.

6. The apparatus according to claim 5, wherein the memory mapping unit includes:
a control module for determining whether the data to be read is compressed data according to a compression record table; and
a memory for storing the compression record table.

7. The apparatus according to claim 5, wherein when the determination indicates that the data to be read is not compressed data, the memory mapping unit further enables the compression and decompression unit to output the data to be read to the processor.

8. The apparatus according to claim 1, wherein the data to be written is a file, when the compression criterion is satisfied, the processing unit further enables the compression and decompression unit to compress a portion of the data to be written and produce corresponding compressed data of the portion of the data to be written; the processing unit further determines whether a compression ratio of the portion of the data to be written and the corresponding compressed data of the portion satisfies a compression ratio criterion; when the compression ratio criterion is satisfied, the processing unit furthers enables the compression and decompression unit to compress a remaining portion of data to be written and output the corresponding compressed data of the data to be written to the memory unit.

9. The apparatus according to claim 8, wherein when the compression ratio criterion is not satisfied, the processing unit further enables the compression and decompression unit to stop compression for the data to be written and output the data to be written to the memory unit.

10. The apparatus according to claim 1, wherein the compression and decompression unit includes:
a data compression and decompression module for selectively performing data compression or decompression;
a memory for use by the data compression and decompression module;
a bypass data path for outputting the data to be written to the memory unit in a bypassing manner; and
a switch circuit, wherein the data compression and decompression module and the bypass data path are coupled in parallel between the switch circuit and the processor.

11. The apparatus according to claim 10, wherein the data compression and decompression module outputs the corresponding compressed data to the memory unit, and updates a compression record table to record a storage location of the corresponding compressed data.

12. The apparatus according to claim 11, wherein when the processing unit determines that the compression criterion is not satisfied, the compression and decompression unit further outputs the data to be written to the memory unit through the bypass data path.

13. The apparatus according to claim 10, wherein the data to be written is a file, the compression and decompression unit further includes:
a control module, wherein when the compression criterion is satisfied, the control module enables the data compression and decompression module to compress a portion of the data to be written and produce corresponding compressed data of the portion of the data to be written;
wherein the control module determines whether a compression ratio of the portion of the data to be written and the corresponding compressed data of the portion satisfies a compression ratio criterion; when the compression ratio criterion is satisfied, the control module furthers enables the data compression and decompression module to compress a remaining portion of data to be written and output the corresponding compressed data to the memory unit.

14. The apparatus according to claim 13, wherein when the compression ratio criterion is not satisfied, the control module further enables the compression and decompression unit to stop compression for the data to be written, and the compression and decompression unit further outputs the data to be written to the memory unit through the bypass data path.

15. A data access method, for use in an electronic device, the method comprising:
determining whether a compression criterion is satisfied by a processing unit of the electronic device, wherein the compression criterion includes: whether an idle rate for the processing unit is greater than a first threshold; and
when the compression criterion is satisfied:
enabling a compression and decompression unit of the processing unit to enter a compression mode; and
using the compression and decompression unit, compressing data to be written and accordingly outputting corresponding compressed data to a memory unit of the electronic device.

16. The data access method according to claim 15, wherein the compression criterion further includes:
whether a write instruction associated with the data to be written has a priority not less than a second threshold; and
whether the data to be written is of a type of compressed data.

17. The data access method according to claim 15, wherein when the compression criterion is not satisfied, the compression and decompression unit is enabled to output the data to be written to the memory unit.

18. The data access method according to claim 15, wherein the data to be written is a file, when the compression criterion is satisfied, the compressing and outputting step further includes:
using the compression and decompression unit, compressing a portion of the data to be written and producing corresponding compressed data of the portion of the data to be written;
determining whether a compression ratio of the portion of the data to be written and the corresponding compressed data of the portion satisfies a compression ratio criterion; and
when the compression ratio criterion is satisfied, enabling the compression and decompression unit to compress a remaining portion of data to be written and output the corresponding compressed data to the memory unit.

19. The data access method according to claim 18, further comprising:
when the compression ratio criterion is not satisfied, enabling the compression and decompression unit to stop compression for the data to be written and output the data to be written to the memory unit.

20. The data access method according to claim 15, further comprising:
recording a storage location of the memory unit in which the corresponding compressed data is stored.

21. The data access method according to claim 15, further comprising:
determining whether the data to be read is compressed data by the processing unit;
if the determination is affirmative:
enabling the compression and decompression unit to enter a decompression mode by the processing unit; and
decompressing the data to be read and accordingly outputting corresponding decompressed data to the processor by the compression and decompression unit.

22. The data access method according to claim 21, further comprising:
if the determination is negative, enabling the compression and decompression unit to output the data to be read to the processing unit in a bypassing manner.
